(19) United States
(12) Patent Application Publication
(10) Pub. No.: US 2017/0127819 A1
(43) Pub. Date: May 11, 2017

(54) Cylindrically-Shaped Toothbrush Assembly With Domed Bristles

(71) Applicant: Thomas D. Warren, Fayetteville, GA (US)

(72) Inventor: Thomas D. Warren, Fayetteville, GA (US)

(21) Appl. No.: 14/933,450

(22) Filed: Nov. 5, 2015

(51) Int. Cl. A46B 13/00; A46B 5/00; B25G 1/10; A46B 9/04; B25G 3/00; A46B 5/02; A46B 9/02

(52) U.S. Cl. CPC A46B 13/001; A46B 5/021; A46B 5/0095; A46B 9/026; A46B 9/04; B25G 3/00; B25G 1/102; A46B 2200/1066

(57) ABSTRACT

The inventive concept disclosed is a toothbrush assembly comprising a cylindrical toothbrush head and a handle. The toothbrush head comprises (1) a cylinder-shaped structure supporting a plurality of bristles radiating orthogonally outward in a complete 360-degree orientation from the axis of the cylinder and (2) a dome-shaped structure attached to the distal end of said rod or cylinder, having a plurality of bristles radiating outward orthogonally from the exterior of said dome. The circumference of the base of the dome is corresponds to the circumference of said cylinder. The proximal end of said toothbrush head may be permanently, or detachably, connected to the handle. This design allows a user of the toothbrush head to continuously have bristles in contact with some portion of the mouth or gums while brushing, and to rotate the cylinder-domed toothbrush head in a multiplicity of directions.

### CROSS-REFERENCES TO RELATED APPLICATIONS

Not applicable

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The disclosed inventive concept is concerned with the efficient cleaning of human teeth, using a different embodiment of a toothbrush having cylindrically-extended bristles. A plethora of types and varieties of toothbrushes are on the market, all having some degree of effectiveness. Mechanical toothbrushes and toothbrush heads are known in the art, as well as electrically-driven toothbrushes. Rotating and vibrating toothbrush heads are used to enhance convenience for the user and possibly cover a greater area of teeth surfaces. Rotating and/or vibrating toothbrush heads improve the accessibility of rearward sections of the upper and lower teeth.

(2) Description of the Related Art, Including Information Disclosed Under 37 CFR 1.97 and 1.98.

U.S. Pat. No. 4,382,309 (May 10, 1983) A toothbrush is disclosed which is capable of cleaning the buccal-labial and lingual surfaces of teeth simultaneously. The method of fabricating the toothbrush is also disclosed. The toothbrush includes a bristle mounting head, a holder for supporting the bristle mounting head and a plurality of cleaning bristles on the bristle mounting head, with the cleaning bristles being in the form of two arcuate or angular shaped bundles of nylon filaments, whose ends are spaced apart and opposed to each other.

U.S. Pat. No. 7,310,846 B1 (Dec. 25, 2007) This is a toothbrush and tongue and mouth cleaner combination, which allows an individual to brush his teeth as well as clean the interior of the mouth, using soft bristles and sponge material. The sponge and soft bristles will be placed inside the interior of a cavity in the handle and operate independently of each other.

U.S. Pat. No. 8,032,967 B2 (Oct. 11, 2011) A powered toothbrush includes a handle having a neck. A head is mounted to the neck and has a first surface and an opposed second surface. A first tuft block is mounted to the head, with the tuft block having tooth cleaning elements extending outwardly from the first surface. A tissue cleanser is mounted to the head and has a plurality of tissue engaging elements extending outwardly from the second surface. A drive assembly configured to cause the first tuft block and the tissue cleanser to move with respect to the head.

U.S. Pat. No. 8,522,382 B2 (Sep. 3, 2013) A penetrating electric toothbrush is disclosed, including a handle, a replaceable brush head, a head unit base, an engaging device, a selection device, and an actuator. The replaceable brush head comprises a head body, a plurality of bristles fixed to the head body, and a detachable fastener. The head unit base has a head receptacle portion, an actuator receiving recess, and a bar guiding portion.

U.S. Pat. No. 8,992,690 (Mar. 31, 2015) In an embodiment of the disclosed technology, a toothbrush head formed of a bristled tread is rotatable about at least one vertically disposed sprocket. The toothbrush head has an elongated neck with sprockets extending axially therefrom. Bristles are wrapped around either or both sprockets.

U.S. Pat. No. 6,582,224 discloses an animal toothbrush which is electrically powered, and further having a battery powered handle with a rotational output shaft coupled to a cylindrical brush.

### BRIEF SUMMARY OF THE INVENTION

Disclosed is a toothbrush assembly having a 360-degree cylindrically-bristled toothbrush head, the toothbrush head further including a dome-shaped bristle aggregation at the distal end of the toothbrush head. The proximal end of the toothbrush head is connected to a handle, either by means of a one-piece integral structure, or by a manually detachable mechanism. In another embodiment, the toothbrush head of the assembly may be rotated axially in either direction by means of connection to an electrically-powered drive shaft.

The toothbrush head comprises (1) a cylinder-shaped structure supporting a plurality of bristles radiating orthogonally outward in a complete 360-degree orientation from the axis of the cylinder and (2) a dome-shaped structure attached to the proximal end of said cylinder and having a plurality of bristles radiating orthogonally outward from the exterior of the dome structure.

This construction allows a user of the cylinder-domed toothbrush to continuously have bristles in contact with some portion of the mouth or gums while brushing, to move the cylinder-domed toothbrush in a multiplicity of directions, and to also brush both the upper and lower sets of teeth simultaneously.

### BRIEF DESCRIPTION OF THE VIEWS OF THE DRAWINGS

FIG. 1 is a general view of an integral, manual toothbrush assembly with bristles extending from its cylinder and dome structures.

FIG. 2 displays the cylinder and dome structures, both disconnected, and prior to bristles being attached to each component.

FIG. 3 illustrates a separable toothbrush assembly showing its toothbrush head manually attached to its handle.

FIG. 4 shows an enlarged sectional view of the detachable domed toothbrush head of the separable toothbrush assembly, according to section line 4-4 of FIG. 3.

FIG. 5 is a view of the separable manual handle and its keyed neck.

FIG. 6 presents a sectional view of the keyed neck of the separable manual handle, according to section line 6-6 of FIG. 5.

FIG. 7 illustrates an electric toothbrush assembly, including the combination of upper and lower drive shafts.

FIG. 8 is a stylized view of an electrically-driven toothbrush head detached from the electric toothbrush assembly.

FIG. 9 presents a sectional view of the electrically-driven toothbrush head according to section line 9-9 of FIG. 8.

FIG. 10 is an enlarged view of the upper and lower drive shafts of the electric toothbrush assembly of FIG. 7.

FIG. 11 displays a sectional view of the upper drive shaft of the electric toothbrush assembly, as seen from section line 11-11 of FIG. 10.

FIG. 12 illustrates an alternative electrically-equipped handle having a multiple-position on-off switch.

FIG. 13 is a view of a different embodiment of a drive shaft mechanism for the electric toothbrush assembly.

FIG. 14 displays a side view of the drive shaft mechanism of FIG. 13

### DETAILED DESCRIPTION OF THE INVENTION

The objects, features, and advantages of the inventive concept presented in this application are more readily understood when referring to the accompanying drawings. The drawings, totaling fourteen figures, show the basic components and functions of the preferred embodiment and at least one alternate embodiment. In the several figures, like reference numbers are used in each figure to correspond to the same component as may be depicted in other figures.

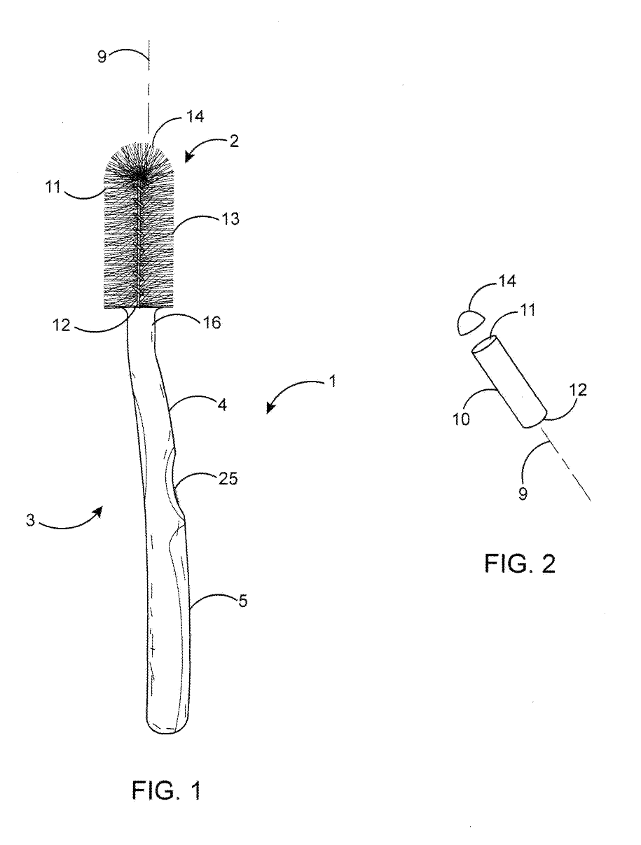

In referring to FIG. 1, there is shown an integral toothbrush assembly 1. The integral toothbrush assembly 1 comprises a manual toothbrush head 2 and an integral manual handle 3. The manual toothbrush head 2 comprises a circular cylindrical structure having a distal end 11 and a proximal end 12. The cylindrical structure (a cylinder 10 as shown in FIG. 2) supports a plurality of bristles 13 radiating orthogonally outward along the length of the cylinder 10 in a complete 360-degree orientation orthogonal to the axis 9 of the cylinder 10. A dome-shaped structure 14 integral to the distal end 11 of said cylinder 10 features a plurality of bristles 13 radiating outward in an orthogonal orientation to the surface of the dome 14. The circumference of the base of the dome 14 is oriented perpendicular to the axis 9 of the cylinder 10

In viewing FIG. 2, there are displayed separate renderings of the cylinder 10 and dome structure 14. The cylinder 10 and dome 14 may be manufactured as one integral unit or as two separate components attached with a permanent adhesive. The cylinder 10 further is characterized by a distal end 11 and a proximal end 12. The axis 9 of the cylinder 10 represents the center of rotational movement of the cylinder 10 when electrically powered by means of a connecting driveshaft, as will be discussed later. Both the cylinder 10 and dome 14 are fabricated with a plurality of bristles 13 extending orthogonally outward from the exterior surface of each structure.

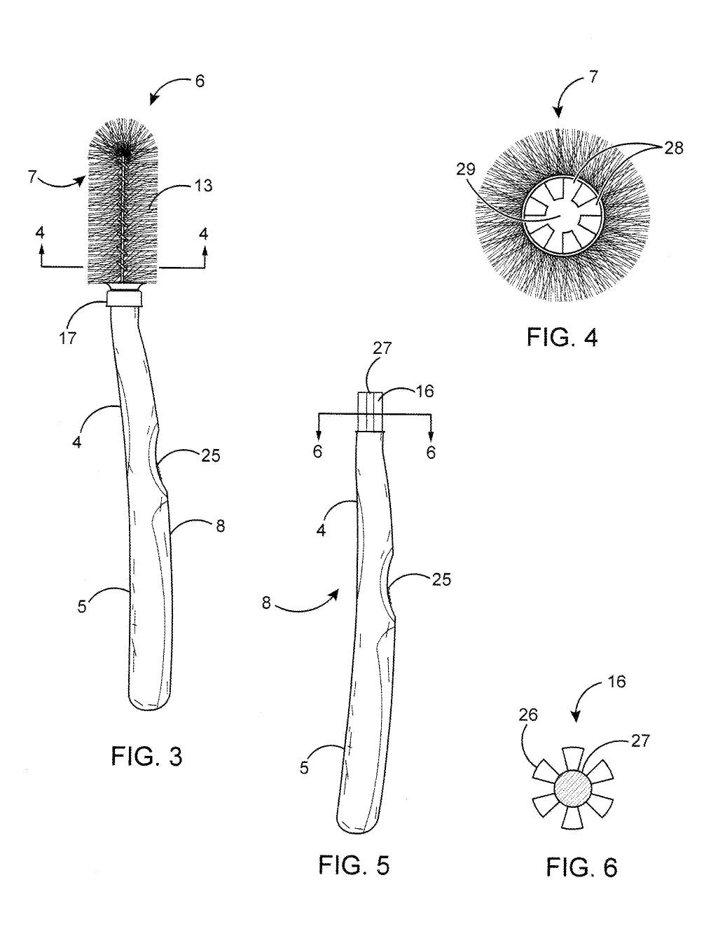

FIG. 3 illustrates a separable toothbrush assembly 6, further showing a detachable manual toothbrush head 7, its bristles 13, and the separable manual handle 8. The separable manual handle 8 further comprises an upper handle 4 and a lower handle 5. An internally threaded collar 17 may be provided for extending the useable reach of the manual toothbrush head 7 coaxially to the neck 16 of the handle 8. For user convenience, a thumb rest 25 is also provided. The embodiment of the separable manual handle 8 shown is constructed with a keyed neck 16, shown in FIG. 5.

FIG. 4 shows an enlarged sectional view of the detachable manual toothbrush head 7 of the separable toothbrush assembly 6, according to section line 4-4 of FIG. 3. The embodiment of the detachable manual toothbrush head 7 shown features an internal cylindrical cavity comprising a post opening 29 and a plurality of keyways 28. The detachable manual toothbrush head 7 of FIG. 4 is designed to be compatible with the keyed neck 16 of the separable manual handle as shown in FIG. 5 and FIG. 6.

In viewing FIG. 5, the separable manual handle 8 is shown separated from the detachable manual toothbrush head 7, with the keyed neck 16 visible. FIG. 6 displays an enlarged sectional view of the keyed neck 16, including a plurality of keys 26 integrally attached to a key post 27. When affixing the detachable manual toothbrush head 7 to the separable manual handle 8, the key post 27 and keys 26 of the keyed neck 16 correspond to the post opening 29 and keyways 28, respectively, of the detachable manual toothbrush head 7.

The descriptions set forth in this section of the document are not intended to limit the means by which a detachable manual toothbrush head, as disclosed, may be attached to a manual toothbrush handle. A variety of mechanical, magnetic, or other attaching means may be utilized to conform to the inventive concept of the cylindrically-shaped toothbrush head and toothbrush assembly disclosed.

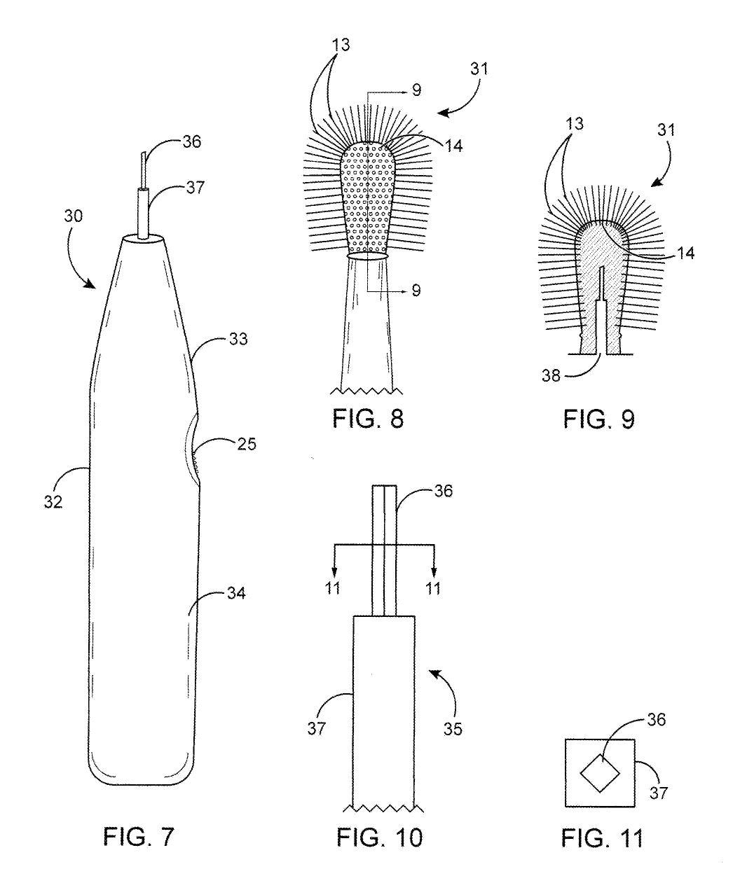

FIG. 7 presents an electric toothbrush assembly 30 including a toothbrush head 31 (ref. FIG. 8) connecting mechanism comprising an upper drive shaft 36 and an integral lower drive shaft 37. The upper drive shaft 36 and lower drive shaft 37 both comprise an external contour which corresponds to the dimensions and internal contour of a cavity existing within a toothbrush head similar to the cylindrically-shaped and domed electrically-driven toothbrush head 31. Also shown is an electrically-equipped handle 32 which is constructed with an internal drive assembly (not shown) in the vicinity of the handle shoulder 33. The internal drive assembly, when powered, transmits an axial rotational force to the upper and lower drive shafts 36, 37 of the electric toothbrush assembly 30. FIG. 8 is a stylized rendering of an embodiment of an electrically-driven toothbrush head 31.

The upper and lower drive shafts 36, 37 comprise a driving mechanism of a conventional type commonly known in the art of hand-held power tools, and electric and/or cordless toothbrushes currently on the market. Examples of electric toothbrushes include Oral-B®, Smilex®, Sonicare®, and Pursonic®. The cordless toothbrushes are referred to herein merely as an example, without regard to specific power output and other requirements necessary for powering a toothbrush or toothbrush head. Considering the disclosure of the inventive concept set forth herein, a person of ordinary skill in the art will easily ascertain the specific requirements of the present invention in selecting an appropriate drive assembly. The ultimate result is that the internal drive assembly 33 serves to provide powered rotation of the electrically-driven toothbrush head 31.

FIG. 8 is a stylized view of an electrically-driven toothbrush head 31 which is compatible with the electric toothbrush assembly 30 of FIG. 7. FIG. 9 presents a sectional view of the electrically-driven toothbrush head 31 according to section line 9-9 of FIG. 8. A drive opening 38 internal to the electrically-driven toothbrush head 31 corresponds to the drive shaft 35 (including the upper and lower drive shafts 36, 37) of the electric toothbrush assembly 30.

FIG. 10 is an enlarged view of the entirety of the drive shaft 35 integral to the electric toothbrush assembly 30. FIG. 11 displays a sectional view of the upper drive shaft 36, as seen from section line 11-11 of FIG. 10, along with the top surface of the lower drive shaft 37 of the electric toothbrush assembly 30,

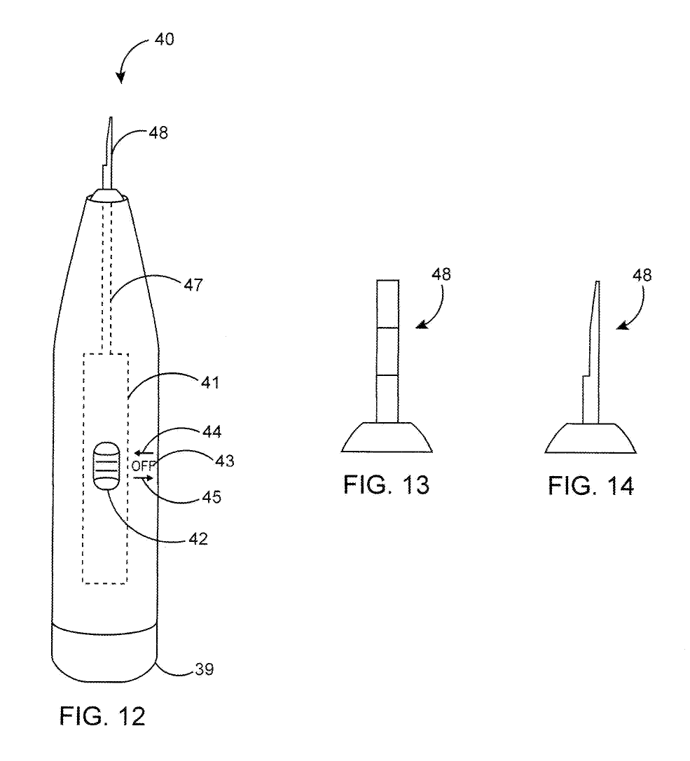

FIG. 12 illustrates an alternative embodiment of an electrically-equipped handle 40, also having a driveshaft connector 48 and a multiple-position on-off switch 43. The alternative embodiment is characterized by a rotational drive means comprising an internal drive assembly 47. The drive assembly 47 is mechanically affixed to the driveshaft connector 48. The driveshaft connector 48 may be powered by an internal electric motor.

The electric motor is powered by series-wired dry-cell batteries located within a battery compartment 41. Other powering means would include a rechargeable battery powered by an ac-dc converter housed in the base 39 of the alternative electric-equipped handle 40. Further, the alternative electric-equipped handle 40 may be driven from external power supply, as from household current.

A multiple-position switch 43 is utilized to provide, through the internal drive shaft 47, rotation of the driveshaft connector 48 in a first rotational direction 44, or in the opposite, second rotational direction 45. Another embodiment of the multiple-position switch 43 may comprise a rotary or sliding switch with the capability of varying the current available to the drive assembly 47, thereby providing a range of rotational speeds for the electrically-driven toothbrush head as disclosed herein.

FIG. 13 is a view of a different embodiment of a drive shaft connector 48 for the alternative electric-equipped handle 40. The external contour of the drive shaft connector 48 corresponds to the internal dimensions and contour of a compatible electrically-driven toothbrush head extending axially therefrom, similar to the disclosures set forth in this document. FIG. 14 displays a side view of the embodiment of the drive shaft connector 48 shown in FIG. 13 for the alternative electric-equipped handle 40.

While preferred embodiments of the present inventive concept have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

What is claimed is:

1. A toothbrush assembly having a toothbrush head portion and a handle portion, comprising:
said toothbrush head having a cylinder with bristles attached to the cylinder and protruding outward from the outer surface of the cylinder and radiating outward in a 360-degree orthogonal orientation from the axis of said cylinder, further having, at the distal end of said cylinder, a dome-shaped structure supporting an aggregation of bristles, said bristles radiating orthogonally from the outer surface of said dome, the center of the base of said dome being oriented co-axially with the axis of the cylinder of the toothbrush head, the proximal end of said cylinder being integral to the handle;
said handle comprising essentially the shape of a circular cross-sectioned rod, with the handle having a first end integral to the proximal end of said cylinder, a semi-rigid material forming a gripping surface on the exterior of said handle, and said handle extending axially away from its first end to culminate in the second end of the handle.

2. A toothbrush assembly according to claim 1, wherein the toothbrush head and the handle comprise two separate components, and further comprising a means for mechanically detaching the proximal end of the cylinder of the toothbrush head from the first end of the handle and subsequently re-attaching the proximal end of the cylinder of the same or an identical toothbrush head to the first end of the handle.

3. A toothbrush assembly according to claim 1, wherein the toothbrush head and the handle comprise two separate components, and further wherein said means for detaching the proximal end of the cylinder of the toothbrush head from the first end of the handle, comprises a handle having a series of symmetrically-shaped, spaced-apart vertical keys, said keys axially aligned with the first end of the handle, and the toothbrush having a series of integral, symmetrically-shaped, spaced-apart internal keyways corresponding to the cross-sections of the keys of said handle, whereby the toothbrush head may be attached and re-attached to the first end of the handle.

4. A tooth brush assembly having a toothbrush head portion and a separate handle portion, comprising:
a toothbrush head having a cylinder comprised of bristles radiating in a 360-degree orientation from the axis of said cylinder and, at the distal end of said cylinder, a dome-shaped structure supporting an aggregation of bristles, said bristles radiating orthogonally from the outer surface of said dome, the center of the base of said dome being oriented co-axially with the axis of the cylinder of the toothbrush head;
said handle comprising essentially the shape of a rod, with the handle having a first end comprising a means of attaching the first end of said handle to, and detaching the first end of said handle from, the proximal end of said toothbrush head, and having a second end of said handle comprising structure a semi-rigid material forming a gripping surface on the exterior of said handle for a user,
an electrically-powered rotating mechanism within the handle, said mechanism providing a means of axially rotating the first end of said handle; and
a multiple-position switch on the exterior of said handle, said switch having an “On” position for providing electrical power to the rotating mechanism, a position for rotating the axis of the first end of said handle in one direction, a position for rotating the first end of said handle in the opposite direction, and an “Off” position for terminating electrical power to the rotating mechanism.

5. A toothbrush assembly having a toothbrush head portion and a separate handle portion, comprising:
said toothbrush head having a cylinder with bristles attached to the cylinder and protruding outward from the outer surface of the cylinder and radiating outward in a 360-degree orthogonal orientation from the axis of said cylinder, further having, at the distal end of said cylinder, a dome-shaped structure supporting an aggregation of bristles, said bristles radiating orthogonally from the outer surface of said dome, the center of the base of said dome being oriented co-axially with the axis of the cylinder of the toothbrush head, the proximal end of said cylinder being integral to the handle;
said handle comprising essentially the shape of a circular cross-sectioned rod, with the handle having a first end integral to the proximal end of said cylinder, a semi-rigid material forming a gripping surface on the exterior of said handle, said handle extending axially away from its first end to culminate in the second end of the handle;
a means for mechanically detaching the proximal end of the cylinder of the toothbrush head from the first end of the handle; and
said handle further having an internally-mounted electric-powered, rotational drive mechanism, said mechanism connecting to a lower drive shaft and an integral upper drive shaft, both drive shafts protruding from the first end of the handle, wherein the upper and lower drive shafts comprise external dimensions and profiles corresponding to the inner dimensions and profile of a cavity fabricated at the proximal end of the cylinder of said toothbrush head.

6. A toothbrush assembly according to claim 5, further comprising an on-off switch having electrically opposed contacts, thereby providing axial rotation of the cylinder of the toothbrush head in either direction about its longitudinal axis.
